(19) United States
(12) Patent Application Publication
(10) Pub. No.: US 2016/0286128 A1
(43) Pub. Date: Sep. 29, 2016

(54) AMPHIBIOUS VTOL SUPER DRONE CAMERA IN A MOBILE CASE (PHONE CASE) WITH MULTIPLE AERIAL AND AQUATIC FLIGHT MODES FOR CAPTURING PANORAMIC VIRTUAL REALITY VIEWS, SELFIE AND INTERACTIVE VIDEO

(71) Applicant: Dylan TX Zhou, Tiburon, CA (US)

(72) Inventor: Dylan TX Zhou, Tiburon, CA (US)

(21) Appl. No.: 15/172,673

(22) Filed: Jun. 3, 2016

Related U.S. Application Data
(63) Continuation-in-part of application No. 14/815,988, filed on Aug. 1, 2015, now Pat. No. 9,342,829.
Application No. 14/815,988 is a continuation-in-part of application No. 13/760,214, filed on Feb. 6, 2013, now Pat. No. 9,016,565.
Application No. 13/760,214 is a continuation-in-part of application No. 13/623,944, filed on Sep. 21, 2012.
Application No. 13/623,944 is a continuation-in-part of application No. 13/620,775, filed on Sep. 15, 2012, now abandoned.
Application No. 13/620,775 is a continuation-in-part of application No. 13/343,044, filed on Jan. 4, 2012, now abandoned.
Application No. 13/343,044 is a continuation-in-part of application No. 13/287,279, filed on Nov. 2, 2011, now abandoned.
Application No. 13/287,279 is a continuation-in-part of application No. 12/749,412, filed on Mar. 29, 2010, now abandoned.
Application No. 12/749,412 is a continuation-in-part of application No. 29/564,817, filed on May 16, 2016.
Application No. 29/564,817 is a continuation-in-part of application No. 29/547,912, filed on Dec. 9, 2015.
(60) Provisional application No. 60/415,546, filed on Oct. 1, 2002.

(51) Int. Cl. H04N 5/232; H04N 7/00; B64C 39/02; H04N 5/38

(52) U.S. Cl. CPC H04N 5/23248; H04N 5/38; H04N 5/23238; H04N 7/00; B64C 39/024; B64C 2201/127; B64C 2201/027; B64C 2201/108; B64C 2201/042; B64C 2201/141; B64C 2201/146; B64C 2201/185; B64C 2201/128; B64D 2211/00

(57) ABSTRACT

A mobile case system comprising a real time broadcast stream recording; an unmanned aerial vehicle; a camera stabilization device; a camera movement device; one or more onboard cameras providing real-time first-person video and real-time first-person views and and 360-degree panoramic video recording used for virtual reality views and interactive video; a video transmitter and receiver device configured to perform high definition low latency real time video downlink; a one and two way telemetry device; a live broadcast device; a headset enabling real-time first-person video; a public database for viewing flight activity; software for licensing videos with a watermarked preview; software for autonomously extracting and compiling the usable video footage into a video montage synced to music; and onboard or separate software for stitching videos to form virtual reality views or interactive video, alternative embodiments the case may be adapted as power bank memory device, and use for aerial delivery.

### CROSS-REFERENCE TO RELATED APPLICATIONS

This application is a continuation-in-part of U.S. application Ser. No. 9/564,817; entitled “AMPHIBIOUS VTOL FOLDING SUPER DRONE CAMERA” filed May 16, 2016 which is a continuation-in part of U.S. application Ser. No. 29/547,912; entitled: AMPHIBIOUS VERTICAL TAKEOFF AND LANDING UNMANNED PHONE CASE DRONE WITH MULTIPLE AERIAL AND AQUATIC FLIGHT MODES FOR CAPTURING PANORAMIC VIRTUAL REALITY VIEWS AND INTERACTIVE VIDEO, WITH EXTRA BATTERY AND MULTIPLE DIMENSIONS COMPATIBLE TO ALL MOBILE PHONE BRANDS, AND WITH MOBILE AND WEARABLE APPLICATION, filed Dec. 9, 2015. This application is also a continuation-in-part of U.S. application Ser. No.: 14/940,379, entitled “AMPHIBIOUS VERTICAL TAKEOFF AND LANDING UNMANNED SYSTEM AND FLYING CAR WITH MULTIPLE AERIAL AND AQUATIC FLIGHT MODES FOR CAPTURING PANORAMIC VIRTUAL REALITY VIEWS, INTERACTIVE VIDEO AND TRANSPORTATION WITH MOBILE AND WEARABLE APPLICATION”, filed Nov. 13, 2015, which is a continuation-in-part of application Ser. No. 14/817,341 filed on Aug. 4, 2015, now U.S. Pat. No. 9,208,505 which is a continuation-in-part of U.S. patent application Ser. No. 14/815,988, entitled “SYSTEMS AND METHODS FOR MOBILE APPLICATION, WEARABLE APPLICATION, TRANSACTIONAL MESSAGING, CALLING, DIGITAL MULTIMEDIA CAPTURE AND PAYMENT TRANSACTIONS”, filed on Aug. 1, 2015, which is a continuation-in-part of U.S. patent application Ser. No. 14/034,509, entitled “EFFICIENT TRANSACTIONAL MESSAGING BETWEEN LOOSELY COUPLED CLIENT AND SERVER OVER MULTIPLE INTERMITTENT NETWORKS WITH POLICY BASED ROUTING”, filed on Sep. 23, 2013, which is a continuation of U.S. patent application Ser. No. 10/677,098, entitled “EFFICIENT TRANSACTIONAL MESSAGING BETWEEN LOOSELY COUPLED CLIENT AND SERVER OVER MULTIPLE INTERMITTENT NETWORKS WITH POLICY BASED ROUTING”, filed on Sep. 30, 2003, which claims priority to US Provisional Patent Application No. 60/415,546, entitled “DATA PROCESSING SYSTEM”, filed on Oct. 1, 2002, which are incorporated herein by reference in their entirety.

### FIELD OF INVENTION

The present invention relates a phone case. More specifically, the present invention relates to phone case which has a drone and a camera in the phone case.

### BACKGROUND OF INVENTION

The conventional phone case usually meant for protecting the phone.

### OBJECT OF INVENTION

The objective of the present invention to utilize a drone and a camera in the phone case and helping the user to capture videos.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

A mobile case system, the system comprising: a real time broad cast stream recording; an unmanned aerial vehicle; a camera stabilization device; a camera movement device configured move the camera; one or more on board cameras for providing a real-time first-person video and a real-time first-person view and normal footage video recording and 360-degree panoramic video recording used for virtual reality views and interactive video; a video transmitter and receiver device configured to perform high definition low latency real time video downlink, wherein the video transmitter and receiver device is a high power, high gain, and ultra-high frequency device; a one way and two way telemetry device; a live broadcast device; a headset configured to enable the real-time first-person video and a real-time first-person view; a public database for viewing flight or dive activity; plurality of software for licensing videos with a watermarked preview; software for autonomously extracting usable footage and compiling the usable footage into a video montage synced to music; On-board or separate software for stitching photos to form a modified photo; and on board or separate software for stitching videos to form virtual reality views or interactive video. a battery , the battery is used as power bank , a memory unit, the memory unit is used as On the go for the mobile phone.

### BRIEF DESCRIPTION OF DRAWING

FIG. 1 is a close up of the isometric view of the first example of the present invention.

FIG. 2 is a close up of the front view of the first example of the present invention.

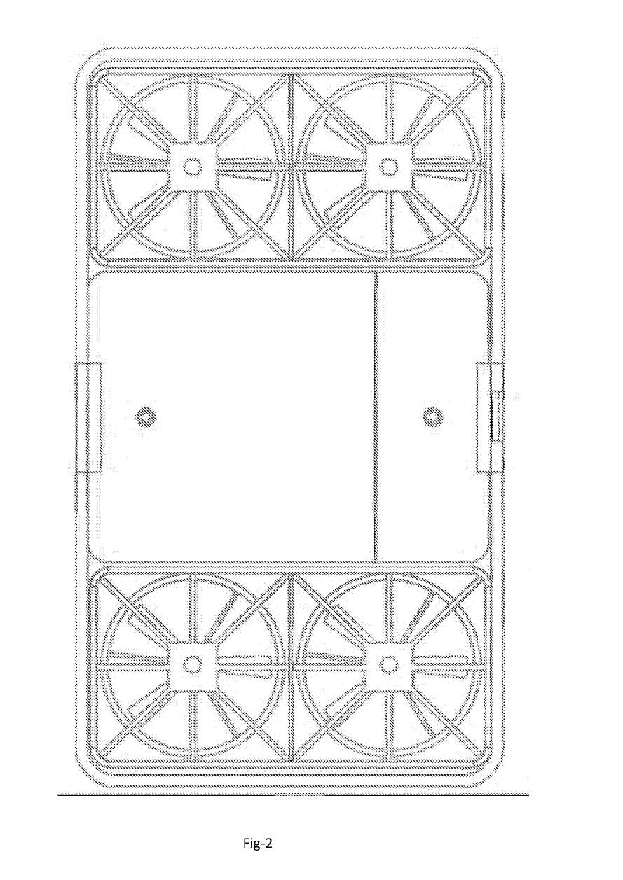

FIG. 3 is a close up of the back view of the first example of the present invention.

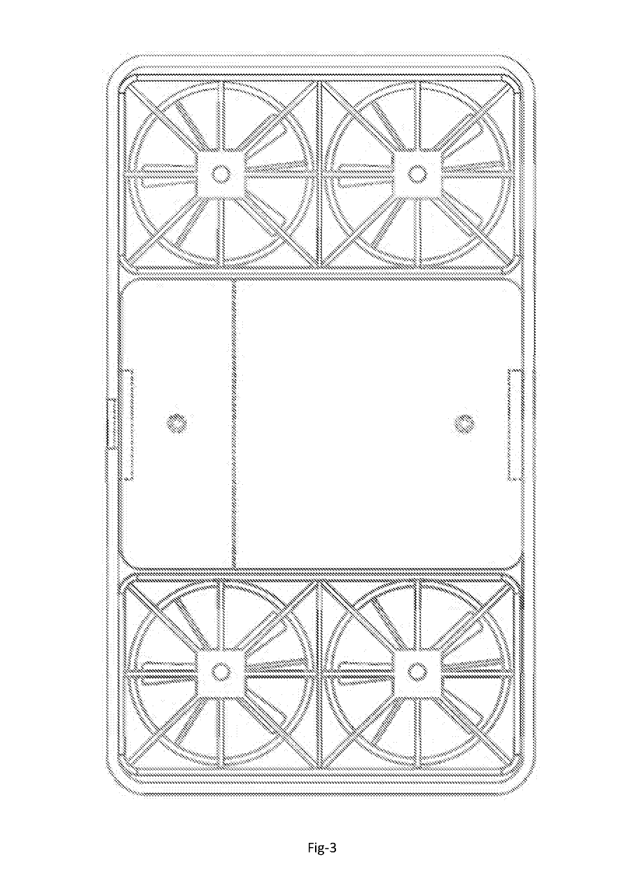

FIG. 4 is a close up of the right view of the first example of the present invention.

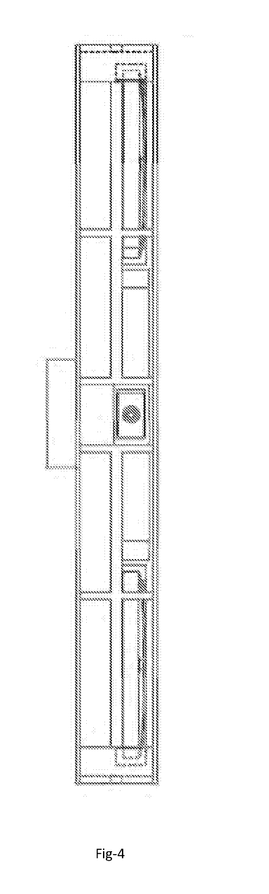

FIG. 5 is a close up of the left view of the first example of the present invention.

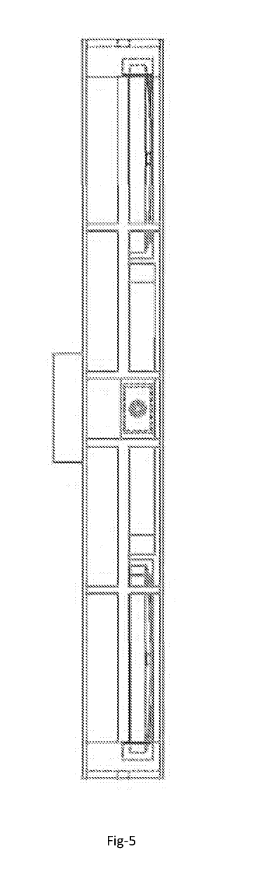

FIG. 6 is a close up of the top view of the first example of the present invention.

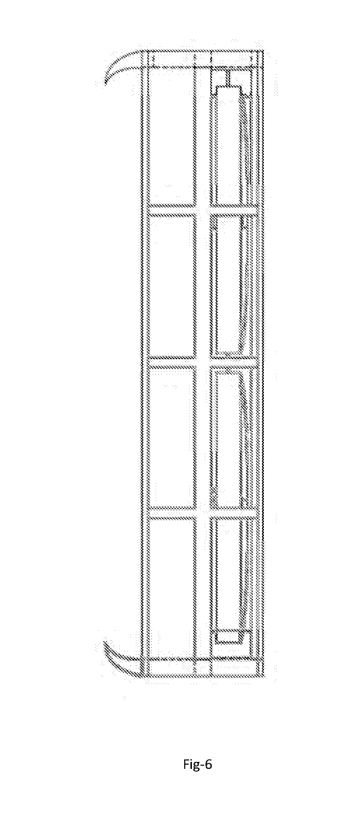

FIG. 7 is a close up of the bottom view of the first example of the present invention.

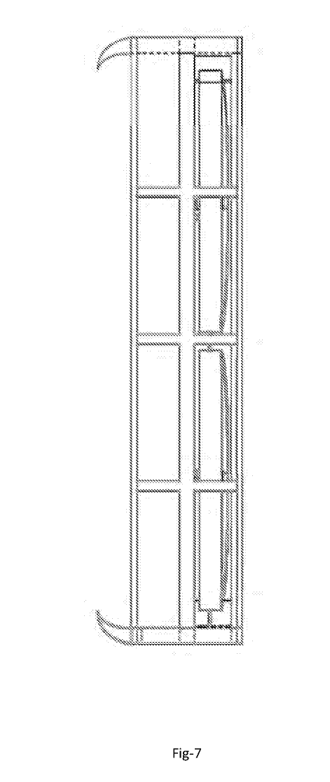

FIG. 8 is a close up of the isometric view of the second example of the present invention.

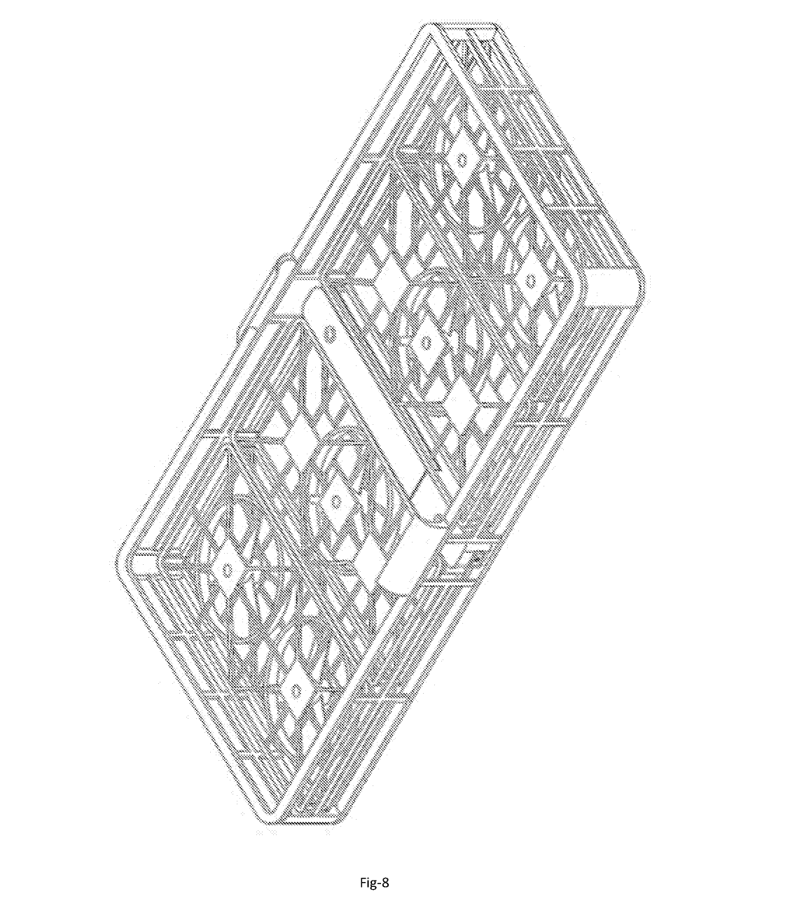

FIG. 9 is a close up of the isometric view of the third example of the present invention.

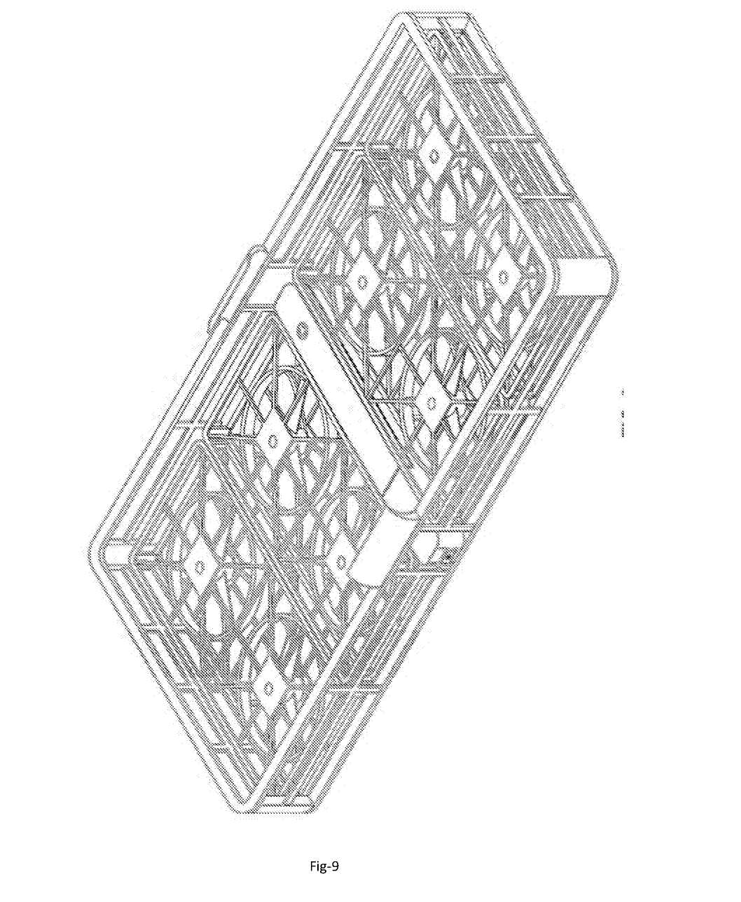

FIG. 10 is a close up of the isometric view of the fourth example of the present invention.

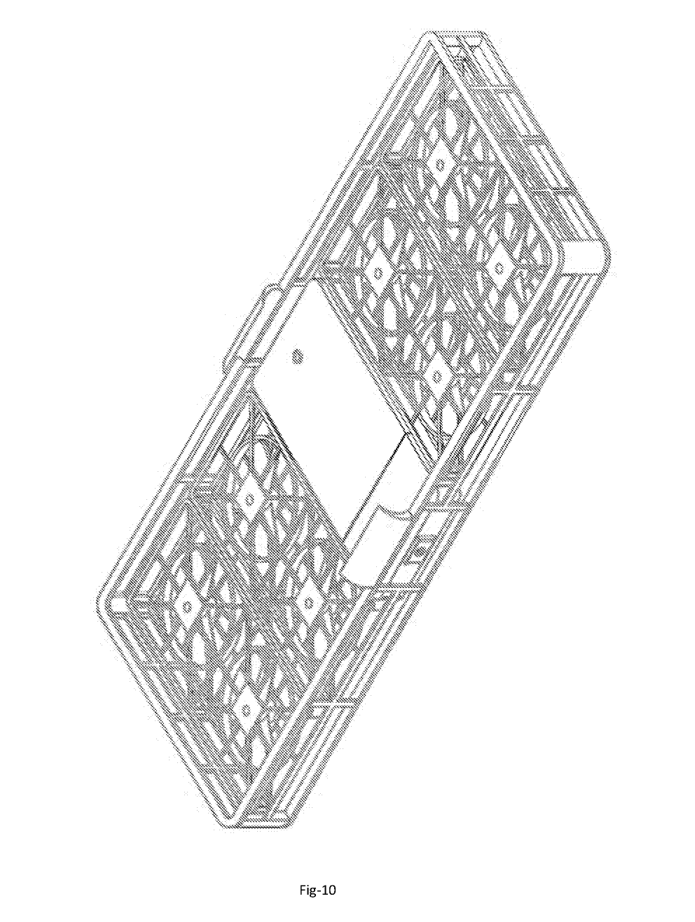

FIG. 11 is a close up of the isometric view of the fifth example of the present invention.

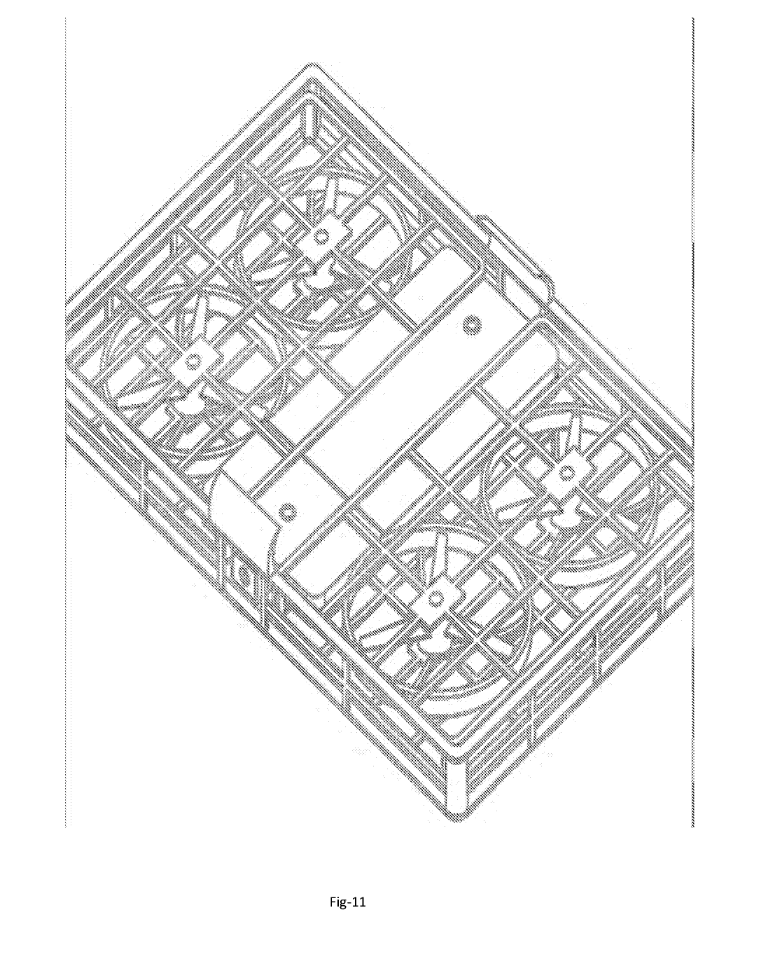

FIG. 12 is a close up of the front view of the fifth example of the present invention.

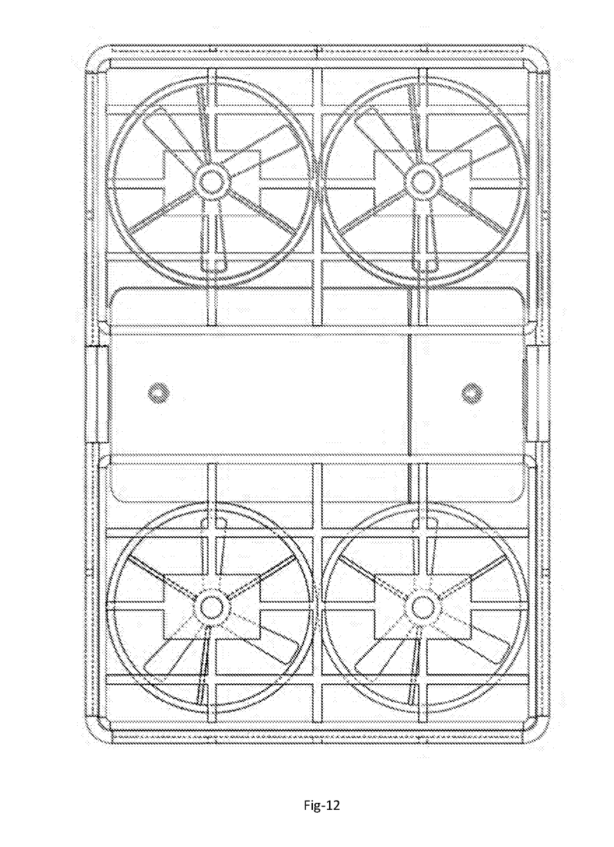

FIG. 13 is a close up of the back view of the fifth example of the present invention.

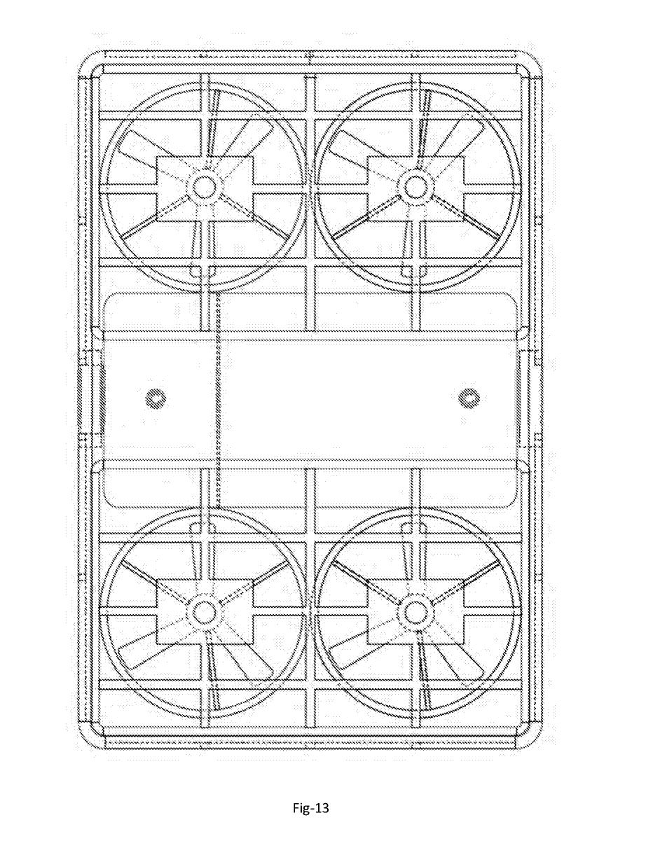

FIG. 14 is a close up of the top view of the fifth example of the present invention.

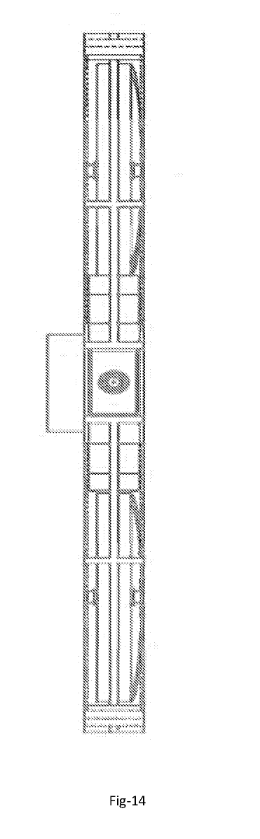

FIG. 15 is a close up of the bottom view of the fifth example of the present invention.

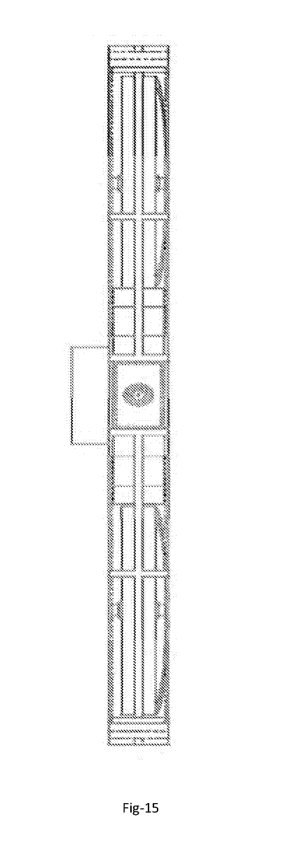

FIG. 16 is a close up of the isometric view of the sixth example of the present invention

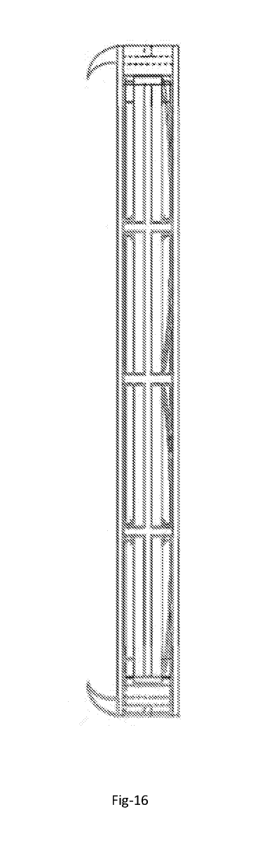

FIG. 17 is a close up of the isometric view of the seventh example of the present invention

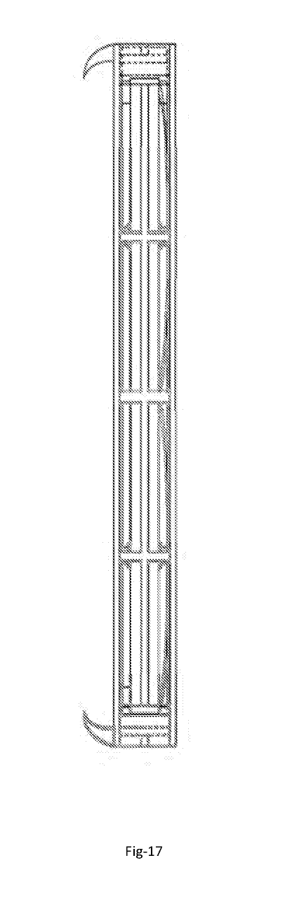

FIG. 18 is a close up of the isometric view of the eighth example of the present invention

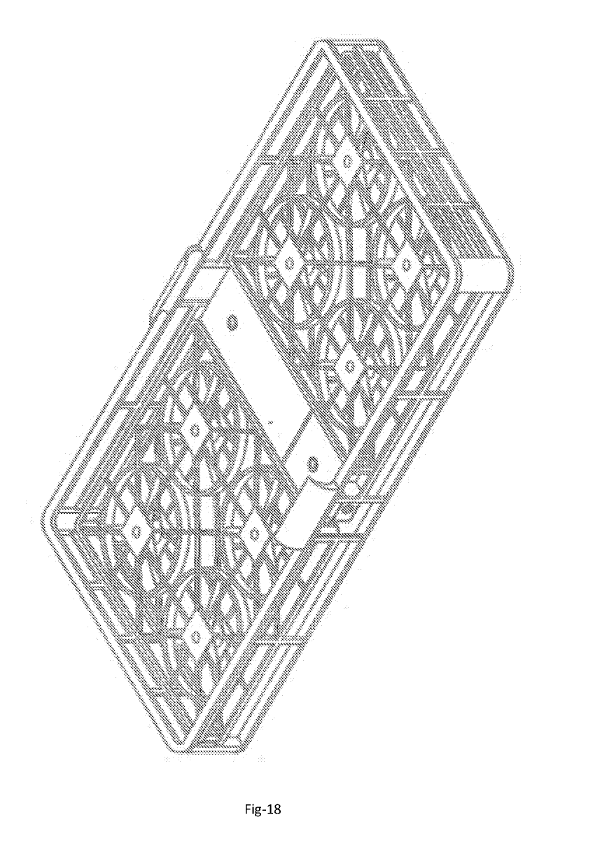

FIG. 19 is a close up of the isometric view of the ninth example of the present invention

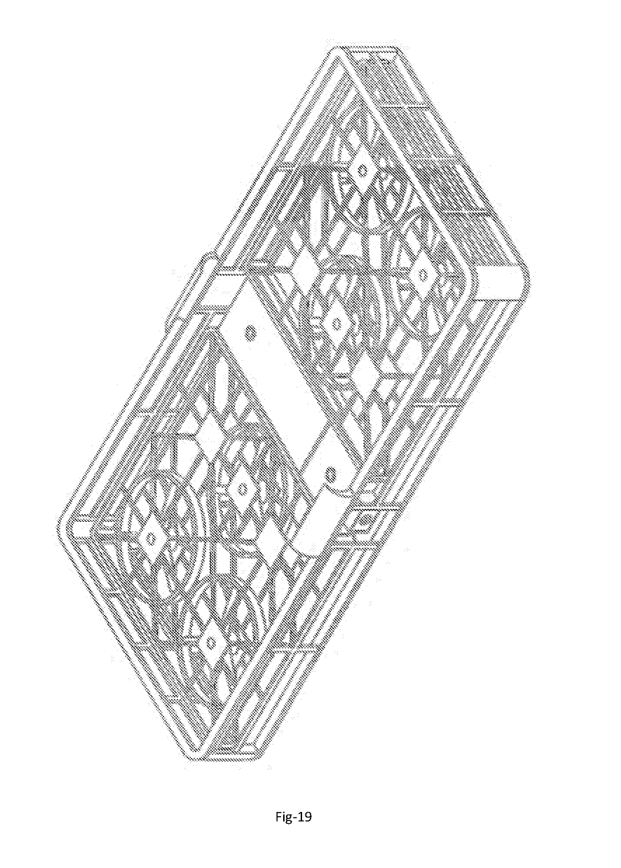

### DETAILED DESCRIPTION OF INVENTION

All illustrations of the drawings are for the purpose of describing selected versions of the present invention and are not intended to limit the scope of the present invention.

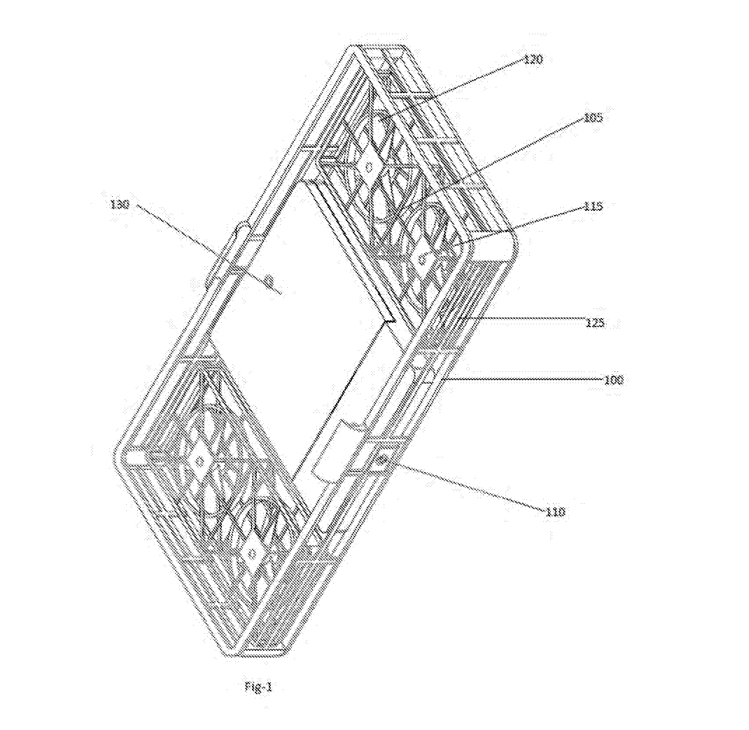

Referring now to the drawings, FIG. 1 illustrates a mobile case 100, an unmanned aerial device 105, according to an example embodiment. The unmanned vehicle 105 also referred herein to as the drone 105 may be used for photography and video capturing.

As shown on FIG. 1 the unmanned device may be single axis or coaxial motor system and may be propelled by a direct drive, for example when propellers 120 are directly attached to a motor, or by belts and pulleys, chains and sprockets, magnets, and/or rigid links, where the propellers 120 may be indirectly linked to the motor shaft. The motors may be powered by electricity or high pressure fluid, including gas.

The device 100 may further include a tilt fuselage device, a tilt wing device, and a tilt motor device. Additionally, the device 100 may include a battery. The shape of the battery may conform to the interior shape of the device 100 to maximize the use of the internal volume of the device 100. The device 100 may include through-wall wire and antenna feedthroughs which may be sealed to prevent water leakage. The two-way telemetry transmitter may send GPS coordinates back to the operator in the case of the device 100 is lost. Referring back to FIG. 1, the device 100 may include a cooling system. The cooling system may be selected from ventilation cooling units, heat sink cooling units, liquid cooling units, and fan cooling units. The device 100 may further include a detachable skin or shell for impact absorption and scratch protection. Furthermore, device 100 may include lights for clear camera vision or lights for signalling, such as for the reception of a command, warning messages, and/or status reports. In case the device 100 is a multimotor vehicle, the device 100 may utilize a lap counter that may function by communication between a sensor and an on board transponder. The multimotor vehicle may utilize a quick connect payload system which may operate by a click in place, snap in place, screw in place, or slide in place mechanism. The device 100 may comprise at least one claw for grasping instruments used to observe or capture specimens, handle specimens, and transportation. The device 100 may comprise an inclined launching platform. In example embodiments, device 100 may be launched at an obtuse angle to the ground for expedient take-off.

The device 100 may further include a deployable parachute in case of the failure of the device 100 when airborne.

The multimotor vehicle may include devices for internally housing or externally attaching a payload of goods. As an example of an externally housed payload, the device 100 may comprise a motorized or pressurized latch mechanism attached onto the payload or payload housing for an impermanent time period. As an example of an internally housed payload, the device 100 may comprise an empty internal storage area that may be accessed by a motorized or pressurized hatch. The payload may be left at the destination by ways involving the device 100 to descend to an altitude below 15 feet. The payload may also be left at the destination by a free fall parachute or a guided parachute.

The device 100 may further include an integrated modular electronics system that may include a central flight control component (including sensors and control parameters), electronic speed controllers, a power distribution harness or board, a telemetry module, a radio control receiver, and a video transmitter. The power distribution board may serve as the platform upon which the other electronics components may be linked to each other and the power distribution board by numerous pins, soldering connections, and a minimal amount of wires. The various components may be arranged to compact within a single board that can be serviced with hardware updates. Individual electronics components may be substituted if broken or outdated, simply by disordering a one part solder connection or detaching a two part pin connection or plug connection.

In another example embodiment, increased battery 130 capacity may be desired for endurance flights. The swappable hatches may accommodate a battery 130 within a waterproof shell, and may be substituted with the hatch to fasten the described dual purpose battery hatch-module.

The device 100 may further include a radio control and video systems that may run on different very high frequency (30-300 MHz), ultra-high frequency (300 MHz-3 GHz), or super high frequency (3-30 GHz) channels. The very high and ultra-high frequency categories offer the best obstacle penetration and may be used with high gain (10-30 dBic) antennas and high power (800 mw-10 w) transmitter/receiver sets for wireless underwater communication and long range aerial communication.

The device 100 may include onboard or separate media editing systems for virtual reality views, interactive video, or stitched photos. If the onboard media editing systems are used, a transformed footage may be downlinked to the operator in real time with low latency. When low latency footage cannot be achieved, the onboard media editing systems may transform the media before or shortly after landing. If onboard media editing systems are not implemented, post-capture media editing methods may be applied.

In an example embodiment, the plurality of motors 115 and propellers 120 may include ducted propellers 120, such as multi-blade ducted fans, fixed pitch propellers, controllable pitch propellers, two-position propellers 120, full feathering propellers 120, and tilted propellers 120.

In a further example embodiment, the plurality of motors 115 and propellers 120 may include two motors 115 and propellers 120, three motors 115 and propellers 120, four motors 115 and propellers 120, five motors 115 and propellers 120, and six motors 115 and propellers. In an example embodiment, at least one of the plurality of motors 115 and propellers 120 is located on a foldable wing, the foldable wing folding in a ground mode and unfolding in a flight mode.

In a further embodiment, the motor 115 may be a solar turbine powered master impeller motor disposed centrally in the device 100. The solar turbine powered master impeller motor may include an electric-drive impeller. The electric-drive impeller may be contained in a compression chamber and may have an axis of rotation oriented perpendicularly to an axis of the device 100. The solar turbine powered master impeller motor 115 may be powered by a solar film. The solar film may be integrated on an upper surface of the device, a lower surface of the device 100, and the at least one wing of the device. The solar turbine powered master impeller motor 115 may be further powered by the electrical power storage device.

A further example embodiment, according to which the device 100 may have a propeller protection system. The propeller protection system may include a wing tip folding mechanism.

The propeller protection system may fully or partially surrounds any type of propellers, such as self-tightening fixed pitch propellers and variable pitch propellers.

In further example embodiments, the device 800 may include a surface skidding material platform and a landing system. The lending system may conforms to a landing surface. Additionally, the device 800 may include one or more control surfaces selected from a group comprising: a rudder, an aileron, a flap, and elevator. The device 800 may be operable to perform an automatic landing and an automatic takeoff.

In an example embodiment, the device 800 further includes a ballast. The ballast may be a permanently fixed ballast or a detachable ballast. Additionally, the device 800 may include an onboard air compressor, an onboard electrolysis system, at least one waterproof through-body wire or antenna feed-through.

In an example embodiment, the device 100 may further include a battery 130. A shape of the battery 130 may conform to an interior profile of the modular and expandable waterproof body. The battery 130 may be a lithium ion polymer (Li-Po or Li-Poly) battery that conforms to the interior profile, and includes a built-in battery charge indicator.

In another embodiment the battery 130 is used a power bank for a mobile device, the battery 130 is coupled to the solar panel which converts the solar energy and stores in the battery 130.

In a further example embodiment, the device 100 may include a Global Positioning

System (GPS) module, a lost model alert, a cooling device, such as a heat sink, a fan, or a duct, a detachable impact absorbing skin or shell, vision aiding and orientated lights, such as light emitting diodes, one or more hatches, quick connect payloads, a lap counter for racing, a flat or inclined launch platform or footing, one or more claws with at least one degree of freedom, an apparatus for externally attaching a cargo and internally housing the cargo, a charging station for multiple batteries. Therefore, the device 100 may serve as a vehicle for carrying people or cargos. In further example embodiments, the device 100 may be configured as one of the following: an autonomous vehicle, a multi-blade ducted fan roadable electric aircraft, an unscrewed vehicle, a driverless car, a self-driving car, an unmanned aerial vehicle, a drone, a robotic car, a commercial goods and passenger carrying vehicle, a private self-drive vehicle, a family vehicle, a military vehicle, and a law enforcement vehicle.

The device 199 may be configured to sense environmental conditions, navigate without human input, and perform autopiloting. The sensing of the environmental conditions may be performed via one or more of the following: a radar, a lidar, the GPS module, and a computer vision module. The processor of the device 100 may be operable to interpret sensory information to identify navigation paths, obstacles, and signage. The autonomous vehicle may be also operable to update maps based on sensory input to keep track of a position when conditions change or when uncharted environments are entered.

The multi-blade ducted fan roadable electric car may be propelled by one or more electric motors using electrical energy stored in the electrical power storage device.

The storage device is used a on the go for the said mobile device, in another embodiment it is used as usb for the mobile phone, in another embodiment it is used for storing the images captured by the camera 110.

In a further example embodiment, the device 100 may include one or more modules attached to the modular and expandable waterproof body. The one or more modules may include a waterproof battery module, a turbine, a solar panel, a claw, a camera stabilization device, a thermal inspection device, an environmental sample processor, a seismometer, a spectrometer, an osmo sampler, a night vision device, a hollow waterproof module for upgrades, third party gear, and hardware upgrades.

In a further example embodiment, the battery 130 may be partially or completely modular. The electronic speed controllers may be configured to detach from an electronic speed controller stack. The video transmitter and the radio control receiver may be removable for upgrade. The onscreen display telemetry device may be removable for upgrade. The plurality of motors may be removable for upgrade. The flight controller may be configured to detach from the power distribution board.

The cameras 110 for capturing panoramic views may be mounted on a multi-camera spherical rig. The multi-camera spherical rig may be mounted onto a camera stabilization device or a fixed mounting device. A content captured by the cameras may be combined to create a panoramic video.

The device 100 is used to record the videos in 4k resolution, the recorded 4k resolution can adapted for live streaming and broadcasting, the videos can be recorded at different resolutions, the resolutions can be adjusted by a user from the mobile device.

The device 100 is adapted for taking the selfies and aerial view of the user using the device.

Furthermore, the video transmitter and receiver device of the system may be configured to control one or more of the following: an omnidirectional or directional antenna, a low pass filter, a ninety degree adapter, head tracking and eye tracking to manipulate movement of the camera stabilization device for video capture or live playback, antenna tracking on the ground station or onboard.

In an example embodiment, the live broadcast device may include an onboard High

Definition Multimedia Input port operable to transmit standard definition, high definition, virtual reality, and interactive video to one or more bystanders. The interactive video may be broadcasted on at least one of the following: a screen, a projector, a split screen, a switch screen, and the headset. The live broadcast device may further comprise an aerial, ground, and marine vehicle for filming the unmanned device.

The present disclosure also refers to a collision avoidance, flight stabilization, and multi-rotor control system for an unmanned device. The system may be configured as a flying car and may include a flight and dive control device configured to perform one or more of the following: auto level control, altitude hold, return to an operator automatically, return to the operator by manual input, operating auto-recognition camera, monitoring a circular path around a pilot, and controlling autopilot, supporting dynamic and fixed tilting arms. The system may further include one or more sensors and one or more cameras configured to control one or more of the following: obstacle avoidance, terrain and Geographical Information System mapping, close proximity flight including terrain tracing, and crash resistant indoor navigation. The system may additionally include an autonomous takeoff device, an auto-fly or dive to a destination with at least one manually or automatically generated flight plan, an auto-fly or dive to the destination by tracking monuments, a direction lock, a dual operator control device, a transmitter and receiver control device. The transmitter and receiver control device may include one or more antennas. The antennas may be high gain antennas. The transmitter and receiver control device may further include a lock mechanism operated by one or more of the following: numerical passwords, word passwords, fingerprint recognition, face recognition, eye recognition, and a physical key. The system may further include at least one electronic speed controllers (ESC) selected from a standalone ESC and an ESC integrated into a power distribution board of the unmanned device. The ESC may be operable to program a motor spin direction without reconnecting wires by the user via spinning a motor in a predetermined direction, and record an input.

The device 100 is attached to a mobile device wherein the mobile device is a smart phone, the mobile device is tablet, wherein the mobile device is augmented reality head mounted display, the head mounted display the augmented reality of the fight control and camera pictures, the battery status in the head mounted display.

The device 100, is coupled with a mobile application wherein the mobile application is used to control the unmanned vehicle.

In another embodiment the application consists of a user interface wherein the user interface receives the information regarding the camera and the flight conditions of the unmanned vehicle.

In another embodiment, the user interface display the first person view and images captured by the device.

In another embodiment, the UI display the available battery present and altitude and manuveours of the unmanned vehicle.

The system may further include a radio control device operable to control an omnidirectional or directional antenna, antenna tracking on a ground station or onboard the unmanned device tilt, a low pass filter, ninety degree adapter, a detachable module for RC communication on a channel having a frequency selected from 72 MHz, 75 MHz, 433 MHz, and 1.2/1.3 GHz, adjustable dual rates and exponential values, at least one dial or joystick for controlling the movement of a camera stabilization device, one or more foot pedals, a slider, a potentiometer, and a switch to transition between a flight profile and a dive profile.

The radio control device may be controlled by stick inputs and motion gestures. In further embodiments, the radio control device may be further operable to perform automatic obstacle avoidance and automatic manoeuvring around an obstacle when the unmanned device performs a flight in a predetermined direction. For example, when the user wants the unmanned device to fly forwards through obstacles, such as trees, the user needs only to signal the unmanned device to go forwards, and the unmanned device may autonomously dodge through the obstacles. Additionally, the radio control device may be operable to turn on a swarm follow-me function by instructing a plurality of unmanned devices to follow a single subject and capture a plurality of views of the subject, where different unmanned devices capture different views of the same subject.

In further example embodiments, the system may further include a navigation device. The navigation device may be configured to enable autonomous flying at low altitude and avoiding obstacles, evaluate and select landing sites in an unmapped terrain, and land safely using a computerized self-generated approach path. Furthermore, the system may be configured to enable a pilot aid to help a pilot to avoid obstacles, such as power lines, and select landing sites in unimproved areas, such as emergency scenes, during operating in low-light or low-visibility conditions. Furthermore, the system may be configured to detect and maneuver around a man lift during flying, detect high-tension wires over a desert terrain, and enable operation in a near earth obstacle rich environment, The system may also include a navigation sensor configured to map an unknown area where obstructions limited landing sites and identify level landing sites with approach paths that are accessible for evacuating a simulated casualty. The navigation sensor may be configured to build three-dimensional maps of a ground and find obstacles in a path, detect four-inch-high pallets, chain link fences, vegetation, people and objects that block a landing site, enable continuously identifying potential landing sites and develop landing approaches and abort paths. Additionally, the navigation sensor may be configured to select a safe landing site being closest to a given set of coordinates. The navigation sensor may include an inertial sensor and a laser scanner configured to look forward and down. The navigation sensor may be paired with mapping and obstacle avoidance software, the mapping and obstacle avoidance software may be operable to keep a running rank of the landing sites, approaches and abort paths to enable responding to unexpected circumstances. Additionally, the unmanned device may include a light detection and ranging lidar and an ultrasonic radar sensor.

Another embodiment, the device is used for aerial transportation of device to smaller distance, the unmanned aerial vehicle is a delivery drone, the delivery drone is adapted for to transport packages, food or other goods, the drone can transport medicines and vaccines, and retrieve medical samples, into and out of remote or otherwise inaccessible regions. The drone rapidly deliver defibrillators in the crucial few minutes after cardiac arrests, and include livestream communication capability allowing paramedics to remotely observe and instruct on-scene individuals in how to use the defibrillators.

Thus, various embodiments of the devices are described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A mobile case system, the system comprising:
a real time broad cast stream recording;
an unmanned aerial vehicle;
a camera stabilization device; a camera movement device configured move the camera;
one or more onboard cameras for providing a real-time first-person video and a real-time first-person view and normal footage video recording and 360-degree panoramic video recording used for virtual reality views and interactive video;
a video transmitter and receiver device configured to perform high definition low latency real time video downlink, wherein the video transmitter and receiver device is a high power, high gain, and ultra-high frequency device;
a one way and two way telemetry device; a live broadcast device; a headset configured to enable the real-time first-person video and a real-time first-person view; a public database for viewing flight or dive activity;
Plurality of software for licensing videos with a watermarked preview;
software for autonomously extracting usable footage and compiling the usable footage into a video montage synced to music;
onboard or separate software for stitching videos to form virtual reality views or interactive video: and
a self-portrait Photograph, taken with a digital camera of mobile case drone, the self-portraite photograph shared on social networking services.

2. The system of claim 1, wherein the one or more on board cameras are configured to: adjust one or more of the following parameters: zoom, shutter speed, aperture, ISO, focal length, depth of field, exposure compensation, white balance, video or photo frame size and orientation, camera resolution and frame rates; switch cameras used for live streaming, digitally stabilize video; capture panoramic photos, capture thermal measurements, edit color correction, produce night vision images and video, produce flash; and wherein the one or more cameras have one or more lens filters; wherein the one or more cameras are configured to be mounted on surfaces of the unmanned device on a motorized camera stabilization device or a vibration free mount, the motorized camera stabilization device being actuated by a brushless motor, a brushed motor, a coreless motor, or a geared motor.

3. The system of claim 1, wherein the one or more cameras for capturing panoramic views are mounted on a multi-camera spherical rig, wherein the multi-camera spherical rig is mounted onto a camera stabilization device or a fixed mounting device, wherein a content captured by the one or more cameras are combined to create a panoramic video, wherein the headset is used by a user to view the panoramic video, wherein a viewing angle is controlled by one or more of the following: head tracking, pressing arrow keys, dragging a screen of the headset, and clicking and dragging a compass icon.

4. The system of claim 1, wherein the video transmitter and receiver device is configured to control one or more of the following: an Omni-directional or directional antenna, a low pass filter, a ninety degree adapter, head tracking and eye tracking to manipulate movement of the camera stabilization device for video capture or live playback, antenna tracking on a ground station or onboard.

5. The system of claim 1, wherein the one way and two way telemetry device is configured to control an on screen display to inform a user of battery voltage, current draw, signal strength, minutes flown, minutes left on battery, joystick display, flight and dive mode and profile, amperage draw per unit of time, GPS latitude and longitude coordinates, an operator position relative to a position of the unmanned device, number of GPS satellites, and artificial horizon displayed on a wearable device, the wearable device being selected from a tablet, a phone, and the headset, wherein the one way and two way telemetry device is configured to provide a follow-me mode when the unmanned device uses the wearable device as a virtual tether to track the user via the camera when the user moves.

6. The system of claim 1, wherein the live broadcast device comprises an onboard High Definition Multimedia Input port operable to transmit standard definition, high definition, virtual reality, and interactive video to one or more bystanders, wherein the interactive video is broadcasted on at least one of the following: a screen, a projector, a split screen, a switch screen, and the headset, wherein the live broadcast device further comprises an aerial, ground, and marine vehicle for filming the unmanned device.

7. The system of claim 1, wherein the headset comprises a video receiver selected from an internally housed video receiver, an externally mounted video receiver, and a separate video receiver, and an integrated camera to enable a user to see surroundings.

8. The system of claim 1, wherein the system further consists, a collision avoidance, flight stabilization, and multi-motor control system for an unmanned device, the system comprising: a flight and dive control device configured to perform one or more of the following: auto level control, altitude hold, return to an operator automatically, return to the operator by manual input, operating auto-recognition camera, monitoring a circular path around a pilot, and controlling autopilot, supporting dynamic and fixed tilting arms; one or more sensors and one or more cameras configured to control one or more of the following: obstacle avoidance, terrain and Geographical Information System mapping, close proximity flight including terrain tracing, and crash resistant indoor navigation; an autonomous take-off device; an auto-fly or dive to a destination with at least one manually or automatically generated flight plan, the auto-fly or dive to the destination by tracking monuments, a direction lock; dual operator control; a transmitter and receiver control device comprising one or more antennas, the one or more antennas including high gain antennas; the transmitter and the receiver control device further comprising a lock mechanism operated by one or more of the following: numerical passwords, word passwords, fingerprint recognition, face recognition, eye recognition, and a physical key; and at least one electronic speed controllers (ESC) selected from a standalone ESC and an ESC integrated into a power distribution board of the unmanned device.

9. The system of claim 1, further comprising: a processor, wherein the processor includes a flight controller, wherein the flight controller is selected from an external micro controller or an internal micro controller; and a barometer; an accelerometer; a gyroscope; a GPS; and a magnetometer.

10. The system of claim 1, wherein the flight and dive control device is configured to: perform stable transitions between a hover mode, a full forward flight mode, and an underwater mode; enable or disable a GPS; record flight parameters; allow inverted flight, aerial and aquatic rolls and flips; stabilize proportional, integral, and derivative gains above water and below water; restrict the unmanned device to fly-safe locations; receive and enact force shut-off commands associated with a manufacturer; receive software updates from the manufacturer; activate the unmanned device after a user inputs an arming action or an arming sequence; provide thrust compensation for body inclination by acting as a body pitch suppressor to maintain an altitude in forward flight; and compensate yaw and roll mixing when motors of the unmanned device tilt.

11. The system of claim 1, further comprising a radio control device operable to control one or more of the following: the Omni-directional or directional antenna, antenna tracking on a ground station or onboard the unmanned device tilt, a low pass filter, ninety degree adapter, a detachable module for RC communication on a channel having a frequency selected from 72 MHz, 75 MHz, 433 MHz, and 1.2 GHz and 1.3 GHz, adjustable dual rates and exponential values, at least one dial or joystick for controlling movement of a camera stabilization device, one or more foot pedals, a slider, a potentiometer, and a switch to transition between a flight profile and a dive profile, and wherein the radio control device is further operable to perform automatic obstacle avoidance and automatic maneuvering around an obstacle when the unmanned device performs a flight in a predetermined direction, wherein the radio control device is operable to instruct a plurality of unmanned device to follow a single subject and capture a plurality of views of the subject, wherein the radio control device is controlled by stick inputs and motion gestures.

12. The system of claim 1, further comprising: a navigation device configured to: enable autonomous flying at low altitude and avoiding obstacles; evaluate and select landing sites in an unmapped terrain; land safely using a computerized self-generated approach path; enable a pilot aid to help a pilot to avoid obstacles and select landing sites in unimproved areas during operating in low-light or low-visibility conditions; detect and manoeuvre around a man lift during flying; detect high-tension wires over a desert terrain; and enable operation in a near earth obstacle rich environment; and a navigation sensor configured to map an unknown area where obstructions limited landing sites; identify level landing sites with approach paths that are accessible for evacuating a simulated casualty; build three-dimensional maps of a ground and find obstacles in a path; detect four-inch-high pallets, chain link fences, vegetation, people and objects that block a landing site; enable continuously identifying potential landing sites and develop landing approaches and abort paths; select a safe landing site being closest to a given set of coordinates; wherein the navigation sensor includes an inertial sensor and a laser scanner configured to look forward and down, wherein the navigation sensor is paired with mapping and obstacle avoidance software, the mapping and obstacle avoidance software being operable to keep a running rank of the landing sites, approaches and abort paths to enable responding to unexpected circumstances.

13. The system of claim 1, wherein the ESC are further operable to program a motor spin direction without reconnecting wires by a user via spinning a motor in a predetermined direction, and record an input.

14. The system of claim 1, wherein the system includes an open source code and an open source software development kit.

15. The system of claim 1, wherein the one or more sensors are selected from a group comprising: individual sensors, stereo sensors, ultrasonic sensors, infrared sensors, multispectral sensors, optical flow sensors, and volatile organic compound sensors, wherein the one or more sensors are provided for intelligent positioning, collision avoidance, media capturing, surveillance, and monitoring.

16. The system of claim 1, wherein the unmanned aerial vehicle further comprising: plurality of motors, wherein the motors further comprises at least a propeller, the propeller is a aero foil and an antenna to transmit the signals to a control device; a battery, wherein the battery supplies power to the motors and the propellers, wherein the unmanned aerial vehicle is a Hovercraft.

17. The mobile case of claim 1, wherein from the mobile phone further comprises a user interface, the user interface is adapted to control the camera stabilization, the user interface adapted to transmit and receives the signals from the camera, the user interface is adapted to tilt, zoom, pan the camera.

18. The mobile case of claim 1, wherein the mobile case further comprising a chassis, a battery, wherein the battery is coupled to the chassis, the battery adapted to supplies power to the motors.

19. The mobile case of claim 1, wherein the battery is adapted as a power bank to the mobile phone, wherein the mobile case is adapted as a delivery drone, wherein the delivery drone is used to deliver the objects, foodpackets, gifts.

20. The mobile case of claim 1, where in the battery is coupled by a solar panel, wherein the solar panel is adapted for solar energy conversion.

21. The mobile case of claim 16, wherein the drone comprises a memory unit wherein the memory unit stores the videos and pictures captured by the camera, wherein the video are recorded with a 4k resolution, the 4k resolution videos are high definition videos adapted for future video broadcasting.

22. The mobile case of claim 16, wherein the drone adapted for surveillance, the camera is adapted to first person view, wherein the drone is adapted for user to capture selfies and user surrounding view.

23. A method of adapting and controlling a mobile case, comprising:
receiving, an information from an antenna, wherein the antenna is coupled to a drone;
sending, a command to a control device of the drone, from a remote device; and
storing, plurality of images and plurality of videos in the memory device.

24. The method claim 23, wherein the information is received from the antenna, where the antenna is coupled to the control system.

25. The method claim 23, wherein the remote device further comprises, a user interface, a transceiver, the user interface displays the information received from the antenna of the drone.

26. The method claim 23, wherein the command from a user on the user interface is transmitted to the control device through the transceiver.

27. The method claim 23, wherein the user interface display information about a camera stabilization device, a flight stabilizing device and battery information.

28. The method claim 23, wherein the user interface control the camera stabilization, the user interface control a first person view of the camera.

29. The method claim 23, where in the remote device is a mobile device, wherein the mobile device is a smart phone, the mobile device is a tablet, wherein the mobile device is a head mounted display, wherein the head mounted device is an augmented reality wearable device.

30. The method claim 23, wherein the user interface is a software, wherein the user interface is a application on the smart phone.
